(19) United States
(12) Patent Application Publication
(10) Pub. No.: US 2004/0156489 A1
(43) Pub. Date: Aug. 12, 2004

(54) System and method for targeted parts and warranty provisioning

(76) Inventors: Claire S. Vishik, Austin, TX (US); Lalitha Suryanarayana, Austin, TX (US)

Correspondence Address: BRINKS HOFER GILSON & LIONE, P.O. BOX 10395, CHICAGO, IL, 60610, US

(21) Appl. No.: 10/360,529

(22) Filed: Feb. 7, 2003

(51) Int. Cl. H04N 7/173; H04M 15/00; H04M 11/00; H04N 7/16; H04M 3/42

(52) U.S. Cl. 379/102.03; 379/111; 725/133; 725/62; 379/201.01

(57) ABSTRACT

A portable communication device has an integrated metering component to monitor a rechargeable battery in the portable communication device, and to determine a battery replacement condition based thereon. The portable communication device has a second component responsive to the metering component to generate a message to order a replacement battery based on the battery replacement condition. The message is communicated using a wireless transmitter of the portable communication device.

### BACKGROUND OF THE INVENTION

1. Field of the Invention

The present invention relates to methods and systems for replenishing parts and servicing devices.

2. Description of the Related Art

Some pre-paid services act as insurance policies to enable purchasers of equipment with parts needing periodic replacement or servicing to carry out provisioning of services and parts. For example, cellular telephones are sometimes provided with policies or warranties covering replacement of parts such as batteries. In another example, ink jet printers may come with replacement policies for ink jet cartridges.

Characteristics of these policies include: being generic; being prepaid independently of levels of usage; and being the responsibility of subscribers to order parts or report for service when needed. On the back end, just-in-time provisioning systems can monitor inventories and order additional shipments when inventories are low, but do not take into consideration individual systems and equipment.

Current on-device re-supply applications and options are based on a time period that approximates the average need for re-supply or service appointment. Moreover, scheduling of services or reordering parts is manual. Since usage varies widely, the periodic re-supply options tend to be either ahead or behind the actual need. In some cases, the new supply may be ordered too late to avoid downtime.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is a flow chart of an embodiment of a method of providing a targeted replenishment service;

FIG. 2 is a block diagram of an embodiment of a direct replenishment system for a device;

FIG. 3 is a block diagram of an embodiment of a LAN-based implementation for replenishing multiple devices; and

FIG. 4 is a block diagram of an embodiment of another LAN-based implementation for replenishing multiple devices.

### DETAILED DESCRIPTION OF THE PREFERRED EMBODIMENTS

As more devices become network-enabled and have electronic components, inefficiencies of the generic approach to parts and warranty provisioning can be mitigated. In contrast to the generic approach, the present disclosure contemplates monitoring an actual state and metering actual usage of a network-enabled device (e.g. an automobile, a cellular telephone, a printer, a piece of equipment, or a system). Based on the state and usage, the network-enabled device automatically submits orders for services/parts in real-time or near-real-time via a communication network.

Instead of offering generic prepaid policies for equipment, service warranties can be targeted to actual needs of owners and can have coverage with improved extent and structure. For example, instead of a generic 5 years/50,000 miles factory warranty on a car, car manufacturers will be able to provide a certain number of service tokens that may last for shorter periods of time for some types of users, and for extended periods for premium customers, depending on how each car is used and maintained. In another example, the cost of a service contract for a printer can be variable depending on an anticipated need for additional media. Numerous examples may be contemplated.

To take advantage of the networked and electronic nature of some equipment, a flexible replenishment system is based on specific criteria such as levels of usage and/or a state of the equipment, and can work automatically in a push mode if desired. As a result, the warranties and insurance policies can be more personalized and more granular. The system can be monitored and managed by users, owners and/or service providers from a variety of networked devices, such as telephony devices (e.g. cellular telephones and other wireless telephones, and wireline telephones) and computing devices (e.g. personal computers and personal digital assistants).

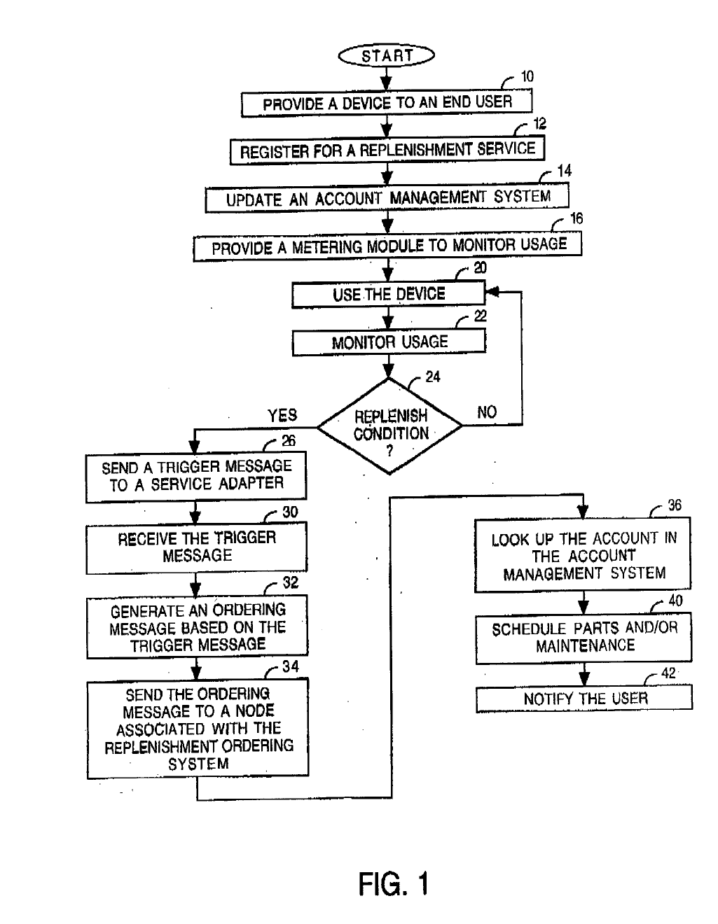

FIG. 1 is a flow chart of an embodiment of a method of providing a targeted replenishment service. As indicated by block 10, the method comprises providing a device to an end user. Numerous examples of the device may be contemplated. Specific examples of the device include, but are not limited to, a wireless telephone such as a cellular telephone, a fire alarm, a smoke detector, a carbon monoxide detector, a printer, a copy machine, a fax machine, an automobile, an air conditioner, a heating system, an air cleaner, a vacuum system, an industrial machine, a home appliance, any device powered by a rechargeable battery, any device powered by disposable batteries, any device having an air filter, lawn equipment (e.g. that may require servicing and/or parts replacement), and any home automation system.

The device has one or more parts that are to be replenished over the course of its life. The one or more parts contribute to the operation of the device. As used in this patent application, the word “replenish” should be construed as being inclusive of any act of replacing, refilling, replenishing, or maintenance.

For example, a printer, copier or fax machine may have either toner cartridge(s) or ink jet cartridge(s) that are replaceable. A wireless telephone may have a rechargeable battery whose ability to retain a charge diminishes after repeated charge cycles, and thus is to be replaced after an extended number of charge cycles. An air conditioner, a heating system, or an air cleaner may have one or more air filters that are to be replaced after collecting particulate matter. A vacuum system may have a filter bag that is to be replaced when full or nearly full. A fire alarm, smoke alarm, or carbon monoxide detector may have a disposable battery that is to be replaced when its charge drops below a threshold. An automobile has multiple parts, e.g. its battery, air filter, oil filter, tires, spark plugs and timing belt, that are to be replaced in the course of its use. Industrial machines may have multiple parts that wear based on their use, and need replacement in light of the wear. A refrigerator may have food items (e.g. milk) that need replenishing.

The act of providing the device to the end user may comprise selling the device to the end user, and/or selling a service associated with the device to the end user. For example, a wireless telephone may be sold to the end user with or without an accompanying wireless telephone service, or may be provided to the end user at no charge as long as the end user subscribes to an accompanying wireless telephone service.

As indicated by block 12, the method comprises registering for a replenishment service. The replenishment subscription may be sold as part of an enhanced warranty for the device and/or one or more particular parts of the device. The replenishment service may be associated with either the device, one or more individual parts of the device, an owner (e.g. a purchaser) of the device, an owner (e.g. a purchaser) of one or more individual parts of the device, or the end user. The owner may be either a person or persons, or may be an entity such as a business or a corporation. It is noted that the present disclosure contemplates the possibility that the owner of the device may differ from the owner of one of the replenishable parts of the device, and thus the warranty service may be associated with either of the owners. A service provider or aggregator of such services can also play a role in this invention.

An example of the act of registering comprises a purchaser of a wireless telephone signing up for a warranty on the wireless telephone. Coverage of the warranty may include a rechargeable battery used to power the wireless telephone.

As indicated by block 14, the method comprises updating an account management system to reflect registration for the replenishment service. The account management system establishes an account identification code to authenticate and/or identify a customer or business in connection with replenishment activities, service contracts and warranty management systems. Each account has one or more entries to reflect each device and/or part whose use and replenishment activities are to be monitored. For example, a consumer can have an account covering his/her automobile, wireless telephones, printers, a washer and a dryer. A small business can have an account covering all of its wireless telephones, printers, copiers and fax machines.

As indicated by block 16, the method comprises providing a metering module to monitor usage of the device and/or its one or more particular parts covered by the replenishment service. The metering module may be either integrated with the device, integrated with a particular part but not integrated with the remainder of the device, attachable and detachable to the device, or attachable and detachable to the particular part. If not integrated with the device or part, the metering module may be provided to the end user based on his/her registering for the replenishment service. In this case, the end user may connect the metering module to the device or part.

An example of an integrated metering module is a module integrated in a wireless telephone that monitors the rechargeable battery. Another example of an integrated metering module is a module integrated with the rechargeable battery itself that monitors the rechargeable battery.

The metering module may be provided in the form of software. For example, the metering module may be provided to the end user in the form of software that is to installed to a computer system (e.g. a personal computer, a personal digital assistant, or another system having a programmable processor).

As indicated by block 20, the end user uses the device. The end user may either actively or passively use the device. Examples of active use of a device include, but are not limited to: initiating print jobs using a printer; communicating with a wireless telephone and recharging its battery; activating an air conditioner, a heating system, or an air cleaner; vacuuming with a vacuum system; driving an automobile; and using an industrial machine. Examples of passive use include, but are not limited to, operating a fire alarm, a smoke alarm, or a carbon monoxide detector in a building such as a home or an office.

As indicated by block 22, the metering module monitors usage of the device or part based on at least one specific criterion set by a manufacturer. Usage may be monitored in terms of an amount of usage time, a count of a number of uses, and/or a measurable property of the device or part. Examples of a measurable property of the device or part include, but are not limited to, a measurable amount of wear of a part, a measurable amount of remaining material in the part or device (e.g. how much toner remains in a cartridge, how much ink remains in an ink jet cartridge), and a measurable amount of material used from the part or by the device (e.g. how much toner has been used from the cartridge, how much ink has been used from an ink jet cartridge)

More specific examples of usage parameters monitored by the metering module are: a resolution-weighted count of a number of pages printed by a printer, copier or fax machine; a measured amount of toner in a toner cartridge; a measured amount of ink in an ink jet cartridge; a number of recharging cycles of a rechargeable battery; a measured ability of a rechargeable battery to retain its charge; a measured amount of operation time for an air conditioner, a heating system, or an air cleaner; a measured amount of particular matter in an air filter; a measured amount of material in a vacuum filter bag; a voltage level of a disposable battery; a number of miles driven for an automobile; and a measured amount of wear of a part in an industrial machine.

As indicated by block 24, the method comprises determining if the monitored usage is such that the specific criterion-or criteria indicates a replenishment condition. This act may be performed by the metering module. In many cases, the criteria include determining if the usage has reached or is beyond a predetermined threshold set by the manufacturer. For the purpose of this patent application, the word “beyond” can mean either greater than or less than depending on the particular comparison being made. Examples of a replenishment condition being triggered include, but are not limited to, when an amount of usage time reaches or exceeds a specific threshold, when a count of a number of uses reaches or exceeds a specific threshold, when a measurable amount of wear of a part exceeds a specific threshold, when a measurable amount of remaining material in the part or device is at or below a specific threshold, and when a measurable amount of material used from the part or by the device reaches or exceeds a specific threshold.

The replenishment condition may be triggered by a combination of criteria. For example, an automobile may have a timing belt that is to be replaced after the sooner of four years or 48,000 miles. In general, the criteria can be combined using logical AND, OR and NOT operations to determine if a replenishment condition is triggered. Fuzzy logic may also be employed to detect a replenishment condition.

Use of the device is repeated and/or continued until a replenishment condition is triggered. In response to the replenishment condition, the metering module sends a trigger message to a service adapter (block 26). The service adapter functions to communicate service-related messages via a computer network or a communication network. The service adapter may be either integrated or non-integrated with the metering module. Thus, in some embodiments, the service adapter may be integrated with the device or the part. For example, the service adapter may be integrated with a wireless telephone or with the rechargeable battery of the wireless telephone. Alternatively, the service adapter may be non-integrated with the metering module, and thus be non-integrated with the device or part. For example, the service adapter may be embodied by a computer that communicates with one or more metering modules via a local area network (LAN). The LAN may be-either wireline or wireless (e.g. BLUETOOTH or 802.11).

The service adapter receives the trigger message (block 30) and generates an ordering message in response thereto (block 32). The service adapter generates the ordering message in a proper format for processing by a replenishment ordering system. The proper format may include an identifier of the part and/or the device, the account identifier, and usage data.

The service adapter sends the ordering message to a node associated with the replenishment ordering system (block 34). Typically, the node is embodied by a computer system accessible via a telecommunication network. The service adapter may send the ordering message via a computer network, such as an Internet or an intranet, a telephony network such as a wireless telephone network or a wireline telephone network, or another telecommunication network.

The node may comprise either a vendor ordering/scheduling system or an intermediary. The vendor ordering/scheduling system is associated with a vendor that acts as a provider of parts and/or services. Thus, the service adapter may send the ordering message directly to a particular vendor associated with the device or part. Alternatively, the service adapter may send the ordering message to an intermediary which aggregates and directs the ordering message to an appropriate one of many vendors based on user-specified or other criteria.

As indicated by block 36, the vendor ordering/scheduling system or intermediary looks up the account in the account management system based on the account identifier. The account management system may be managed by either the service subscription vendor or the intermediary. As indicated by block 40, the method comprises scheduling of parts and/or maintenance service for the device. As indicated by block 42, the method comprises notifying the user of the scheduling of parts and/or maintenance service.

Thus, when an end-of-cycle of a part needing replacement is either detected through measuring usage, determined by a predefined schedule, or indicated by the customer himself, a message is sent to the vendor who may dispatch the part(s) to a pick-up point in the customer's neighborhood. Multiple pick-up points for the customer may be predefined in advance of triggering replenishment. The pick-up points may be modified depending on the context such as if the customer moves his residence or place of business, or if the customer is traveling and needs delivery at a temporary place. For example, a metering program associated with printer drivers can count the number of pages printed, taking into consideration color, resolution, and other printing parameters. When the measurements reach a threshold for the types of cartridges used in the printer, an order is automatically submitted to the provider of the enhanced warranty or service contract.

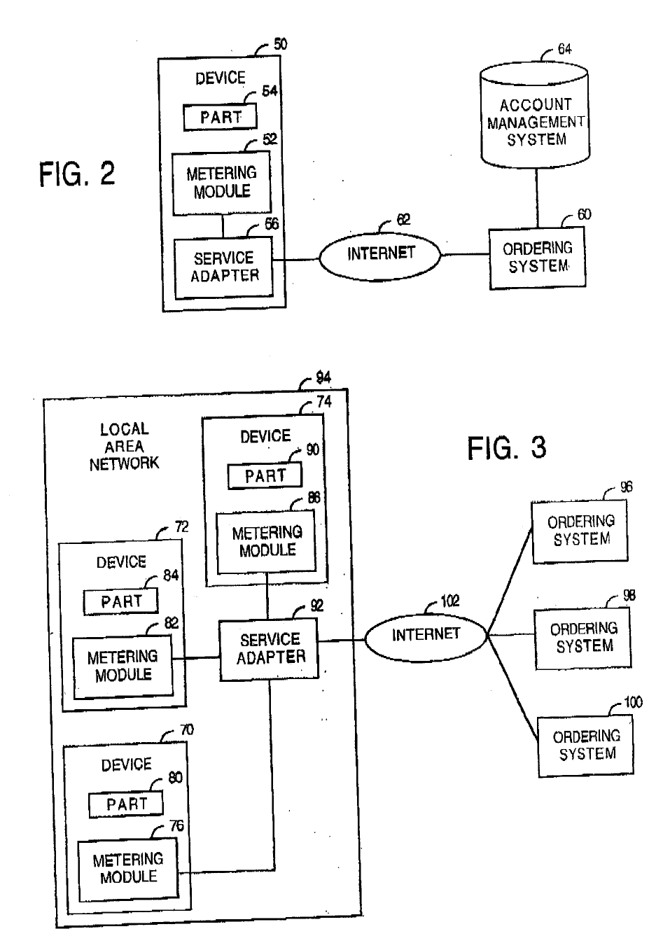

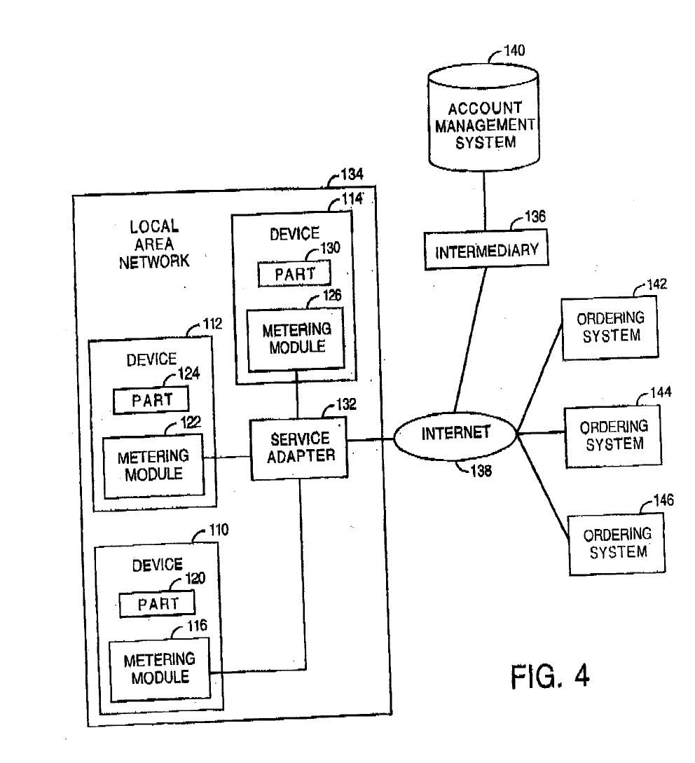

The above-described method can be implemented by various business models and system architectures. Three examples are described with reference to FIGS. 2, 3 and 4. FIGS. 2 and 3 illustrate embodiments of a device-to-vendor/provider model. FIG. 4 illustrates an embodiment of an intermediary-based model.

FIG. 2 is a block diagram of an embodiment of a direct replenishment system for a device 50. A metering module 52 monitors usage of at least one part 54 of the device 50 that is to be replenished based on at least one specific criterion set by a manufacturer. A service adapter 56 is responsive to the metering module 52 to direct the formatting and delivery of an ordering message directly to an ordering system 60 for a vendor of the device 50. The service adapter 56 communicates with the ordering system 60 via the Internet 62. The ordering system 60 accesses an account management system 64 to process the order. The ordering system 60 delivers needed parts or schedules necessary service for the customer. In this embodiment, the service adapter 56 and the metering module 52 may be located on the device 50 itself.

FIG. 3 is a block diagram of an embodiment of a LAN-based implementation for replenishing multiple devices, including devices 70, 72 and 74. A metering module 76 monitors usage of at least one part 80 of the device 70 that is to be replenished based on at least one specific criterion set by a first manufacturer. A metering module 82 monitors usage of at least one part 84 of the device 72 that is to be replenished based on at least one specific criterion set by a second manufacturer. A metering module 86 monitors usage of at least one part 90 of the device 74 that is to be replenished based on at least one specific criterion set by a third manufacturer.

A service adapter 92 is responsive to the metering modules 76, 82 and 86 via a local area network 94. The service adapter 92 may comprise a software system residing on a computer system, such as a home server for example, that directs the routing of individual order requests. Each of the devices 70, 72 and 74 may be either a peripheral of the computer system (e.g. a printer) or a non-peripheral of the computer system (e.g. an air cleaner).

The service adapter 92 is responsive to the metering module 76 to direct the formatting and delivery of an ordering message directly to an ordering system 96 for a vendor of the device 70. The service adapter 92 is responsive to the metering module 82 to direct the formatting and delivery of an ordering message directly to an ordering system 98 for a vendor of the part 84 of the device 72. The service adapter 92 is responsive to the metering module 86 to direct the formatting and delivery of an ordering message directly to an ordering system 100 for a vendor of the device 74. The service adapter 92 communicates with the ordering systems 96, 98 and 100 via the Internet 102. The ordering systems 96, 98 and 100 process their respective orders to deliver needed parts or schedule necessary service for the customer.

FIG. 4 is a block diagram of an embodiment of another LAN-based implementation for replenishing multiple devices, including devices 110, 112 and 114. A metering module 116 monitors usage of at least one part 120 of the device 110 that is to be replenished based on at least one specific criterion set by a first manufacturer. A metering module 122 monitors usage of at least one part 124 of the device 112 that is to be replenished based on at least one specific criterion set by a second manufacturer. A metering module 126 monitors usage of at least one part 130 of the device 114 that is to be replenished based on at least one specific criterion set by a third manufacturer.

A service adapter 132 is responsive to the metering modules 116, 122 and 126 via a local area network 134. The service adapter 132 may comprise a software system residing on a computer system, such as a home server for example, that directs the routing of individual order requests to an intermediary 136. Each of the devices 110, 112 and 114 may be either a peripheral of the computer system (e.g. a printer) or a non-peripheral of the computer system (e.g. an air cleaner). The service adapter 132 communicates with the intermediary 136 via the Internet 138.

The intermediary 136 is a third party that owns and operates a warranty or service subscription system covering many devices and parts. This provider manages warranty contracts for many vendors and takes care of collecting metering reports from subscribers and directing them to vendors, resellers and manufacturers responsible for replenishment. A telecommunication company, such as a regional Bell operating company (RBOC), a wireless telephone service provider, a long distance provider, or a data telecommunication services provider, can operate a service contract management system of this nature.

The intermediary 136 accesses an account management system 140 to process the order and route the order to or otherwise contact an appropriate vendor ordering system. The intermediary 136 directs an ordering message associated with the device 110 to an ordering system 142 for a vendor of the device 110. The intermediary 136 directs an ordering message associated with the device 112 to an ordering system 144 for a vendor of the device 112. The intermediary 136 directs an ordering message associated with the device 114 to an ordering system 146 for a vendor of the device 114. The ordering systems 142, 144 and 146 process their respective orders to deliver needed parts or schedule necessary service for the customer.

Examples of using embodiments of the replenishment method and system are as follows.

### EXAMPLE 1

### Home Printer

Consider a customer who purchases a printer online and selects an enhanced warranty for the printer. When the printer is shipped to the customer, metering and notification software is included with computer-readable media (e.g. a CD-ROM, diskettes, a DVD) having print drivers and software that accompanies the printer. The metering and notification software is installed with the printer drivers into a computer. During installation, the customer selects a convenient pick-up point (e.g. a grocery store) using the computer.

The printer has ink cartridges that are good for 500 pages at a default resolution, and 200 pages at a highest resolution. As the customer uses the printer, the metering module installed in the computer calculates and records an estimated number of ink units remaining in the cartridges. When 20% of the ink units are estimated to remain, the computer automatically sends an ordering message to re-order and deliver replacement cartridges to the grocery store. The customer receives notification when the replacement cartridges are delivered to the pick-up point. Thereafter, the customer may obtain the replacement cartridges from the pick-up point (e.g. an information desk at a grocery store) and is charged at that time. Alternatively, notification of the cartridges' arrival can appear when the customer checks out at the grocery store. In either case, the customer may pay with a registered credit card or the grocery store's loyalty card. The intermediary may be compensated by the vendor or user based on a set of criteria.

### EXAMPLE 2

### Business Printer

A business customer purchases a laser printer with a premium level of service. When the metering module detects that a toner cartridge would need to be replaced soon, an ordering message is sent to the customer's purchasing system. The purchasing system automatically issues a purchase order (PO), and optionally moves the PO along a required approval flow. Alternatively, the message can be submitted to a service contract management (SCM) system of the service provider, and executed within the contract with the business customer.

### EXAMPLE 3

### Telematics/Enhanced Warranty

Consider a car having an embedded computer. The embedded computer is programmed to provide the metering module and the service adapter. When the embedded computer detects that a car component needs replacement, a message is sent to the service provider via a wireless network. The service provider contacts the customer to make an appointment for replacing the car component. The appointment may be made either on-line or off-line. Since the service provider already has information about the car, the customer, the component to be replaced and any needed repairs, the customer can just leave the car at the service provider's parking lot.

### EXAMPLE 4

### Battery for a Portable Communication Device.

A mobile wireless telephone or another portable communication device has an integrated metering component to monitor its rechargeable battery. The metering component can count the number of recharge cycles for the battery and/or measure an effectiveness of the battery to retains its charge, for example. The mobile telephone also has a second component that serves as an integrated service adapter responsive to the metering component.

The metering component determines if a battery replacement condition is present (e.g. if the number of recharge cycles is greater than or equal to a threshold specified by either a manufacturer of the battery or a manufacturer of the wireless telephone). In response to a battery replacement condition determined by the metering component, the second component in the mobile telephone generates a message to order a replacement battery, and communicates the message using the telephone's wireless transmitter to either a battery vendor, a mobile telephone vendor, or an intermediary. The order message comprises either a telephony message (e.g. the mobile telephone automatically dials a telephone number and communicates the message via the mobile telephone network) or a data message (e.g. the mobile telephone automatically sends data via the mobile telephone network in a short messaging service (SMS) message).

Alternatively, the message is locally communicated from the mobile telephone to a networked computer. The networked computer, in turn, communicates the order message to either a battery vendor, a mobile telephone vendor, or an intermediary.

### EXAMPLE 5

### Home Automation

Consider a home automation system having a processor that provides the metering module. The metering module may determine when to re-order filters for a heating/cooling system (e.g. air conditioning) based on air quality and how long air conditioning or heating was on. The service adapter may be integrated with the home automation system, in which case the home automation system itself sends a message to re-order a filter. Alternatively, the home automation system may communicate with a home computer having software installed therein to provide the service adapter.

In summary, the herein-disclosed embodiments are usage-based and targeted to users' actual needs (e.g. re-ordered supplies can be picked up at convenient locations, and supplies are reordered only when required). Suppliers benefit in that they can predict the need for parts and equipment with better precision. Distributors benefit in that they can improve their service. Manufacturers benefit in that they can vary their warranty and extended service models, which may lead to cost savings.

The metering/replenishment-related messages can be received on a variety of devices. The messages can be routed among these devices in an intelligent fashion according to predefined rules. Multiple devices/pieces of equipment can be managed by one system. Access to the system can be multimodal (e.g. speech, text, and point-and-click).

Aspects of the services can be personalized for each individual user. Examples of aspects that can be personalized include, but are not limited to, warranties, replenishment rules and frequencies, suppliers, and alert delivery. Since some decisions are made by the end user and not the manufacturer/supplier, the relationship between the end user and the manufacturer/supplier is improved.

A business model based on the present disclosure may involve a warranty that is not merely an agreement between a provider and a customer (e.g. a wireless telephone service provider and consumer). In contrast, the warranty may involve multiple distributed parties, e.g. the consumer, a software provider, an intermediary, a primary service provider, a delivery point, and a payment/credit company. The intermediary serves a role as a warranty aggregator that can manage replenishment/warranty contracts for multiple pieces of equipment.

It will be apparent to those skilled in the art that the disclosed invention may be modified in numerous ways and may assume many embodiments other than the preferred form specifically set out and described above.

Accordingly, it is intended by the appended claims to cover all modifications of the invention which fall within the true spirit and scope of the invention.

What is claimed is:

1. An apparatus comprising:
a portable communication device having an integrated metering component to monitor a rechargeable battery in the portable communication device and to determine a battery replacement condition based thereon, the portable communication device having a second component responsive to the metering module to generate a message to order a replacement battery based on the battery replacement condition, and to communicate the message using a wireless transmitter of the portable communication device.

2. The apparatus of claim 1 wherein the message is communicated to a battery vendor.

3. The apparatus of claim 1 wherein the message is communicated to a mobile telephone vendor.

4. The apparatus of claim 1 wherein the message is communicated to an intermediary node that facilitates replenishment activities for multiple devices and accounts.

5. The apparatus of claim 1 wherein the message is communicated to a networked computer.

6. The apparatus of claim 1 wherein the integrated metering component is to count a number of recharge cycles of the rechargeable battery in the portable communication device, and to determine the battery replacement condition based on the number of recharge cycles.

7. The apparatus of claim 6 wherein the battery replacement condition is triggered if the number of recharge cycles is greater than or equal to a specific threshold.

8. The apparatus of claim 7 wherein the specific threshold is specified by a manufacturer of the rechargeable battery.

9. The apparatus of claim 7 wherein the specific threshold is specified by a manufacturer of the portable communication device.

10. The apparatus of claim 1 wherein the integrated metering component is to measure an effectiveness of the rechargeable battery to retain its charge, and to determine the battery replacement condition based on the effectiveness.

11. The apparatus of claim 1 wherein the message comprises a wireless telephony message.

12. The apparatus of claim 1 wherein the message comprises a wireless data message.

13. The apparatus of claim 12 wherein the wireless data message comprises a short messaging service (SMS) message.

14. The apparatus of claim 1 wherein the portable communication device comprises a wireless telephone.

15. A method comprising:
selling at least one of a portable communication device and an accompanying wireless service for the portable communication device to a customer, the portable communication device having an integrated metering component to monitor a rechargeable battery in the portable communication device and to determine a battery replacement condition based thereon, the portable communication device having a second component responsive to the metering component to generate a message to order a replacement battery based on the battery replacement condition, the message having a format that is processable by an ordering system, and to communicate the message using a wireless transmitter of the portable communication device;
registering the customer for a replenishment service covering a rechargeable battery of the portable communication device;
receiving the message to order a replacement battery; and
providing the replacement battery to the customer based on the message.

16. The method of claim 15 wherein the replenishment service for the customer includes replenishment activities for at least one device other than the portable communication device.

17. The method of claim 15 wherein the message is received by a battery vendor.

18. The method of claim 15 wherein the message is received by a mobile telephone vendor.

19. The method of claim 15 wherein the message is received by an intermediary node that facilitates replenishment activities for multiple devices and accounts.

20. The method of claim 15 wherein the message is received from the portable communication device.

21. The method of claim 15 wherein the message is received from a network computer in communication with the portable communication device.

22. The method of claim 15 wherein the integrated metering component is to count a number of recharge cycles of the rechargeable battery in the portable communication device, and to determine the battery replacement condition based on the number of recharge cycles.

23. The method of claim 22 wherein the battery replacement condition is triggered if the number of recharge cycles is greater than or equal to a specific threshold.

24. The method of claim 23 wherein the specific threshold is specified by a manufacturer of the rechargeable battery.

25. The method of claim 23 wherein the specific threshold is specified by a manufacturer of the portable communication device.

26. The method of claim 15 wherein the integrated metering component is to measure an effectiveness of the rechargeable battery to retain its charge, and to determine the battery replacement condition based on the effectiveness.

27. The method of claim 15 wherein the message comprises a wireless telephony message.

28. The method of claim 15 wherein the message comprises a wireless data message.

29. The method of claim 15 wherein the portable communication device comprises a wireless telephone.

30. A method of replenishing parts for a plurality of devices including a first device and a second device, the method comprising:
providing a first metering module to monitor usage of a first part contributing to operation of the first device, to detect a replenishment condition for the first part based on the usage and at least one specific criterion set by a first manufacturer, and to generate a first trigger signal to indicate the replenishment condition;
providing a second metering module to monitor usage of a second part contributing to operation of the second device, to detect a replenishment condition for the second part based on the usage and at least one specific criterion set by a second manufacturer, and to generate a second trigger signal to indicate the replenishment condition;
establishing an account covering replenishment activities of the first part and the second part for a particular customer; and
providing a service adapter responsive to the first metering module and the second metering module via a local area network, the service adapter responsive to the first trigger signal to direct formatting and delivery of data to a first ordering system for a first vendor to replenish the first part for the particular customer, the service adapter responsive to the second trigger signal to direct formatting and delivery of data to a second ordering system for a second vendor to replenish the second part for the particular customer.

31. The method of claim 30 wherein the first metering module is integrated with the first device.

32. The method of claim 31 wherein the second metering module is integrated with the second device.

33. The method of claim 30 wherein the first metering module is integrated with the first part.

34. The method of claim 33 wherein the second metering module is integrated with the second part.

35. The method of claim 33 wherein the second metering module is integrated with the second device.

36. The method of claim 30 wherein said providing the service adapter comprises providing computer software to install on a computer system, and wherein the first device and the second device are non-peripherals of the computer system.

37. The method of claim 30 wherein the replenishment condition for the first part is further based on at least one criterion set by the particular customer.

38. The method of claim 30 further comprising compensating an intermediary that manages the account covering replenishment activities for the particular customer.

39. A system for replenishing parts for a plurality of devices including a first device and a second device, the system comprising:
a first metering module to monitor usage of a first part contributing to operation of the first device, the first metering module to detect a replenishment condition for the first part based on the usage and at least one specific criterion set by a first manufacturer, the first metering module to generate a first trigger signal to indicate the replenishment condition;
a second metering module to monitor usage of a second part contributing to operation of the second device, the second metering module to detect a replenishment condition for the second part based on the usage and at least one specific criterion set by a second manufacturer, the second metering module to generate a second trigger signal to indicate the replenishment condition;
an account management system that manages an account covering replenishment activities of the first part and the second part for a particular customer;
a local area network; and
a service adapter responsive to the first metering module and the second metering module via the local area network, the service adapter responsive to the first trigger signal to direct formatting and delivery of data to a first ordering system for a first vendor to replenish the first part for the particular customer, the service adapter responsive to the second trigger signal to direct formatting and delivery of data to a second ordering system for a second vendor to replenish the second part for the particular customer.

40. The system of claim 39 wherein the first metering module is integrated with the first device.

41. The system of claim 40 wherein the second metering module is integrated with the second device.

42. The system of claim 39 wherein the first metering module is integrated with the first part.

43. The system of claim 42 wherein the second metering module is integrated with the second part.

44. The system of claim 42 wherein the second metering module is integrated with the second device.

45. The system of claim 39 wherein the server adapter resides on a computer system, and wherein the first device and the second device are non-peripherals of the computer system.

41. The system of claim 34 wherein the replenishment condition for the first part is further based on at least one criterion set by the particular customer.
